(19) United States
(12) Patent Application Publication
(10) Pub. No.: US 2015/0359026 A1
(43) Pub. Date: Dec. 10, 2015

(54) RADIO COMMUNICATION SYSTEM, RADIO ACCESS NETWORK NODE, COMMUNICATION DEVICE, AND CORE NETWORK NODE

(71) Applicant: NEC CORPORATION, Minato-ku, Tokyo (JP)

(72) Inventors: Takanori IWAI, Tokyo (JP); Hajime ZEMBUTSU, Tokyo (JP)

(73) Assignee: NEC Corporation, Tokyo (JP)

(21) Appl. No.: 14/653,751

(22) PCT Filed: Sep. 20, 2013
(86) PCT No.: PCT/JP2013/005584

§ 371 Date: Jun. 18, 2015

(30) Foreign Application Priority Data
Dec. 21, 2012 (JP) 2012-280030

(51) Int. Cl. H04W 76/02

(52) U.S. Cl. CPC H04W 76/025; H04W 76/021

(57) ABSTRACT

An RAN node (2) is configured to communicate with a device (1) equipped with an embedded UICC in an initial state. Furthermore, the RAN node (2) is configured to communicate with a provisioning network (3) arranged for provisioning of the embedded UICC, and a core network different from the provisioning network. Still furthermore, the RAN node (2) is configured to transmit an attach request message received from the device (1) to the provisioning network (6) instead of the core network (3) of an initial MNO. As a result of this, for example, the device equipped with the eUICC in the initial state can be safely connected to the network operated by the initial MNO.

### TECHNICAL FIELD

The present application relates to provisioning of an embedded UICC (Universal Integrated Circuit Card).

### BACKGROUND ART

A GSM (Global System for Mobile Communications) system, a UMTS (Universal Mobile Telecommunications System), and an LTE (Long Term Evolution) system, etc., use an IC (Integrated Circuit) module that is called a UIM (User Identity Module), an SIM (Subscriber Identity Module), a USIM (Universal Subscriber Identity Module), or a UICC (Universal Integrated Circuit Card), etc., and can be easily removed from a communication device (e.g., a cellular phone terminal, a smartphone, a tablet computer). These IC modules store credentials necessary to access a mobile operator network. The credentials generally include a user identity code (e.g., an IMSI (International Mobile Subscriber Identity)) and a telephone number (e.g., an MSISDN). The credentials may be called identity information or an SIM profile, etc.

The UICC can store various applications including an application (e.g., an SAT (SIM application toolkit) application) that communicates with a communication device in order to update the credentials through OTA (Over the Air), in addition to an SIM application or a USIM application for network authentication. That is, strictly speaking, the UICC is different from the UIM, the SIM, and the USIM. These terms are however often used interchangeably. Accordingly, although the term “UICC” is mainly used in the specification, the term “UICC” in the specification may denote the UIM, the SIM, or the USIM, etc.

Mainly for the purpose of mounting on an M2M (Machine-to-Machine) device and CCE (connected consumer electronics), a new type of SIM called an eUICC (embedded UICC) or an eSIM (embedded SIM) has been discussed by the 3GPP (Third Generation Partnership Project), the ETSI (European Telecommunications Standards Institute), and the GSMA (GSM Association), etc. The eUICC is embedded in a radio communication module or a device equipped with a radio communication module during a manufacturing process of the radio communication module or the device. Specifically, the eUICC is directly soldered to a circuit board. The M2M device may be called an MTC (Machine Type Communication) device. In addition, in regard to the M2M device and the CCE, the term “MCIM (Machine Communication Identity Module)” may be used as the term “SIM” and “USIM”.

It is extremely difficult to replace the eUICC mounted in the device (M2M device or CCE). Accordingly, when a connectable MNO (Mobile Network Operator) is fixed as in a usual SIM/UICC, selection of an MNO by a user of the device is limited. In order to solve such a problem, it is desired to allow credentials of the MNO selected by the user to be downloaded through OTA (Over the Air) at the time of using the device. As a result of this, flexible MNO (Mobile Network Operator) selection according to a utilization situation of the device (e.g., a country or a region where the device is used) or a user's preference, etc., can be achieved. A process of downloading MNO credentials to the eUICC in an initial state is called provisioning or personalization.

One use case regarding the eUICC will be explained hereinafter. An M2M device manufacturer provides an M2M device equipped with the eUICC in the initial state. The eUICC in the initial state stores initial credentials necessary to connect to a provisioning network. The initial credentials include, for example, an IMSI and an MSISDN for connecting to the provisioning network. The provisioning network is connected to a subscription management server. The subscription management server is provided by an organization (Subscription Manager) trusted from a plurality of MNOs. The Subscription Manager is, for example, an organization approved by a standardizing body of the eUICC. The M2M device equipped with the eUICC in the initial state downloads, from the subscription management server to the eUICC by OTA (Over the Air) credentials and other data (e.g., a preferred PLMN (Public Land Mobile Network) list) regarding a particular MNO selected by a user of the M2M device. The provisioned eUICC uses newly written credentials to access a network of the particular MNO. Provisioning of the eUICC and update of the credentials including the above-mentioned use case are, for example, described in Non-Patent Literatures 1 and 2.

### CITATION LIST

### Non Patent Literature

[Non-Patent Literature 1] 3GPP TR 33.812 V9.2.0 (2010-06) “Feasibility study on the security aspects of remote provisioning and change of subscription for Machine to Machine (M2M) equipment (Release 9)”
[Non-Patent Literature 2] GSM Association, “Embedded Mobile Guidelines Version 2”, [online], Mar. 8, 2011, [Search on Oct. 31, 2012], the Internet <URL: http://www.gsma.com/connectedliving/wp-content/uploads/2012/04/whitepaperembeddedmobileguidelinesv2.pdf>

### SUMMARY OF INVENTION

### Technical Problem

In the above-mentioned use case of the eUICC, the eUICC in the initial state stores minimum initial credentials necessary to connect to the provisioning network. Here, an operator of the provisioning network is considered. As a realistic solution, it is assumed that the operator of the provisioning network is any of MNOs consigned from the other MNOs. For example, it is considered that one of MNOs that provide services in a certain country or region provides the provisioning network on consignment from the other MNOs. Hereinafter, the MNO that provides the provisioning network is called an initial MNO. The initial MNO may be approved as a Subscription Manager and operate a subscription management server.

Inventors in the present case have examined a method for safely connecting a device equipped with an eUICC in an initial state to a network of an initial MNO. The initial MNO must permit attach of the M2M device equipped with the eUICC in the initial state for provisioning/personalization of the eUICC. However, the initial MNO also accommodates usual devices (e.g., a cellular phone terminal and a smartphone) each equipped with a usual SIM/UICC. Accommodating the M2M device equipped with the eUICC in the initial state and the usual devices in the common network causes concern about security deterioration.

Non-Patent Literatures 1 and 2 describe only summaries regarding provisioning of the eUICC and update of credentials, and do not describe specific methods and configurations for safely connecting the device equipped with the eUICC in the initial state to the network operated by the initial MNO. Accordingly, one of objects of the present invention is to provide a radio communication system, a radio access network node, a communication device, a core network node, a method and a program that contribute to allowing a device equipped with an eUICC in an initial state to be safely connected to a network operated by an initial MNO.

### Solution to Problem

In a first aspect, a radio communication system includes: a device; a radio access network node; a provisioning network; a core network; and a server. The device is equipped with an embedded UICC in an initial state. The radio access network node is configured to communicate with the device. The provisioning network is a network arranged for provisioning of the embedded UICC. The core network is a network different from the provisioning network. The server is configured to communicate with the device through the provisioning network for provisioning of the embedded UICC. Furthermore, the radio access network node is configured to transmit an attach request message received from the device to the provisioning network instead of the core network.

In a second aspect, a radio access network node includes first and second communication units. The first communication unit is configured to communicate with a device equipped with an embedded UICC in an initial state. The second communication unit is configured to communicate with a provisioning network arranged for provisioning of the embedded UICC and a core network different from the provisioning network. Furthermore, the second communication unit is configured to transmit an attach request message received from the device to the provisioning network instead of the core network.

In a third aspect, a communication device includes: a radio communication unit that communicates with a radio access network node; and an embedded UICC. Furthermore, when the embedded UICC is in an initial state, the radio communication unit is configured to transmit, to the radio access network node, selected network information indicating a provisioning network arranged for provisioning of the embedded UICC.

In a fourth aspect, a communication method in a radio access network node includes: (a) receiving an attach request message from a device equipped with an embedded UICC in an initial state; and (b) transmitting the attach request to a provisioning network instead of a core network.

In a fifth aspect, a communication method in a device equipped with an embedded UICC includes, when the embedded UICC is in an initial state, transmitting to, the radio access network node, selected network information indicating a provisioning network arranged for provisioning of the embedded UICC.

In a sixth aspect, a program includes instructions for causing a computer to perform the method according to the above-mentioned fourth aspect.

In a seventh aspect, a program includes instructions for causing a computer to perform the method in accordance with the above-mentioned fifth aspect.

In an eighth aspect, a subscriber information server includes: a database storing subscriber information; and a communication unit configured to communicate with a mobility management node. Furthermore, the communication unit is configured to, in response to receiving a location update request including initial credentials corresponding to an embedded UICC in an initial state, transmit an answer message indicating an access point name corresponding to a provisioning network arranged for provisioning of the embedded UICC.

In a ninth aspect, a mobility management node includes: a first communication unit configured to communicate with a radio access network node; and a control unit. The control unit is configured to receive an attach request message from the device through the radio access network node. Furthermore, the control unit is configured to, when the attach request message indicates access by an embedded UICC in an initial state or access for provisioning of the embedded UICC, configure a communication path between the radio access network node and a transfer node corresponding to a provisioning network arranged for provisioning of the embedded UICC.

### Advantageous Effects of Invention

According to the above-mentioned aspects, there can be provided a radio communication system, a radio access network node, a communication device, a core network node, a method and a program that contribute to allowing a device equipped with an eUICC in an initial state to be safely connected to a network operated by an initial MNO.

### BRIEF DESCRIPTION OF DRAWINGS

FIG. 1 is a diagram showing a configuration example of a network including a radio communication system in accordance with a first embodiment.

FIG. 2 is a diagram showing a configuration example (in a case of LTE) of the network including the radio communication system in accordance with the first embodiment.

FIG. 3 is a sequence diagram showing one example of an eUICC provisioning procedure in accordance with the first embodiment.

FIG. 4 is a sequence diagram showing one example of the eUICC provisioning procedure in accordance with the first embodiment.

FIG. 5 is a sequence diagram showing one example of the eUICC provisioning procedure in accordance with the first embodiment.

FIG. 6 is a sequence diagram showing one example of the eUICC provisioning procedure in accordance with the first embodiment.

FIG. 7 is a block diagram showing a configuration example of a device in accordance with the first embodiment.

FIG. 8 is a block diagram showing a configuration example of an RAN node in accordance with the first embodiment.

FIG. 9 is a diagram showing a configuration example of a network including a radio communication system in accordance with a second embodiment.

FIG. 10 is a diagram showing a configuration example (in a case of LTE) of the network including the radio communication system in accordance with the second embodiment.

FIG. 11 is a diagram showing a configuration example (in a case of LTE) of the network including the radio communication system in accordance with the second embodiment.

FIG. 12 is a diagram showing a configuration example (in a case of LTE) of the network including the radio communication system in accordance with the second embodiment.

FIG. 13 is a diagram showing a configuration example (in the case of LTE) of the network including the radio communication system in accordance with the second embodiment.

FIG. 14 is a sequence diagram showing one example of an eUICC provisioning procedure in accordance with the second embodiment.

FIG. 15 is a block diagram showing a configuration example of a subscriber information server in accordance with the second embodiment.

FIG. 16 is a diagram showing a configuration example (in a case of LTE) of a network including a radio communication system in accordance with a third embodiment.

FIG. 17 is a sequence diagram showing one example of an eUICC provisioning procedure in accordance with the third embodiment.

FIG. 18 is a block diagram showing a configuration example of a mobility management node in accordance with the third embodiment.

### DESCRIPTION OF EMBODIMENTS

Hereinafter, specific exemplary embodiments shall be explained in detail with reference to the drawings. The same or corresponding components are denoted by the same reference symbols throughout the drawings, and repetitive explanations will be omitted as necessary for the sake of clarity.

### First Embodiment

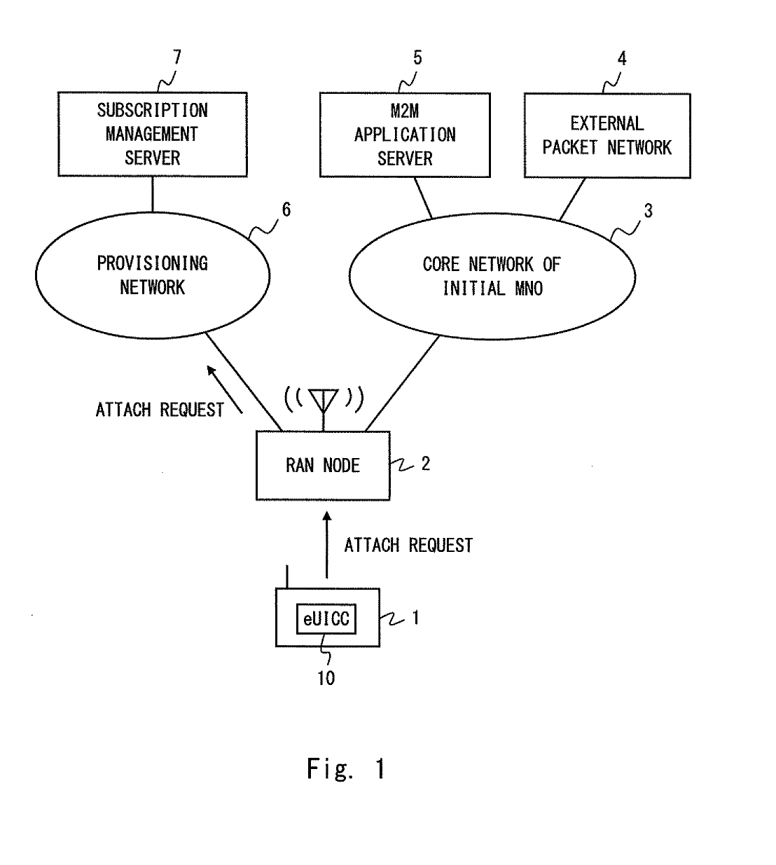

FIG. 1 shows a configuration example of a network including a radio communication system in accordance with the embodiment. A device 1 is equipped with an embedded UICC (eUICC) and has a communication function. The device 1 is, for example, an M2M device or CCE (connected consumer electronics). An RAN (Radio Access Network) node 2 is a node arranged in a radio access network, and communicates with the device 1. Specifically, the RAN node 2 controls communication with the device 1 on a radio interface (an air interface), and relays data between the device 1 and a core network 3 of an initial MNO or a provisioning network 6. The RAN node 2 may be a base station (e.g., an eNodeB (eNB) of LTE) having a radio interface, or may be a base station controller (e.g., an RNC (Radio Network Controller) of a UMTS).

As already mentioned above, the initial MNO in the specification is a MNO that provides the provisioning network 6. The core network 3 of the initial MNO is a mobile core network (e.g., an EPC (Evolved Packet Core) of LTE or a GPRS (general packet radio service) core of a UMTS) to which a terminal having a UICC that stores regular credentials of the initial MNO is allowed to be connected. The terminal having the UICC that stores the regular credentials is, for example, a cellular phone terminal, a smartphone, and a tablet PC. In addition, the terminal having the UICC that stores the regular credentials may be an M2M device or CCE having a eUICC that has already been provisioned. The core network 3 is connected for example to an external packet network 4 and an M2M application server 5. The M2M application server 5 is operated for example by a third party different from the initial MNO, and provides an M2M application service through an API (Application Programming Interface) provided by the core network 3.

Meanwhile, the provisioning network 6 is a network operated by the initial MNO for provisioning/personalization of an eUICC in an initial state. The provisioning network 6 is connected to a subscription management server 7. The subscription management server 7 communicates with the device 1 (specifically, an eUICC 10) through the provisioning network 6. Additionally, the subscription management server 7 downloads credentials regarding a particular MNO and other data (e.g., a preferred PLMN list) to the eUICC 10 through OTA via the provisioning network 6. The particular MNO is, for example, an MNO selected according to an area where the device 1 is used, or an MNO selected by a user of the device 1. After the eUICC 10 has been provisioned, the device 1 is allowed to access a network of the particular MNO. As one example, the subscription management server 7 may provide the device 1 (eUICC 10) with credentials for accessing a network of an MNO different from the initial MNO. In another example, the initial MNO may be selected as the particular MNO. In this case, the device 1 having the provisioned eUICC 10 is allowed to be connected to the core network 3 of the initial MNO as the particular MNO.

Provisioning of the eUICC can be performed using an existing OTA platform used for updating data stored in a usual UICC, for example, an SMS (Short Message Service)-based OTA platform, a CBS (Cell Broadcast Service)-based OTA platform, or an IP (Internet Protocol)-based OTA platform. Accordingly, functions required to be installed in the provisioning network 6 may be determined according to an OTA platform employed for provisioning of the eUICC. For example, when the SMS-based OTA is employed, the provisioning network 6 has an SMS-SC (Short Message Service-Service Center), and controls short message transmission in response to a request from the subscription management server 7. Alternatively, when the CBS-based OTA is employed, the provisioning network 6 has a CBC (Cell Broadcast Centre), and controls cell broadcast in response to a request from the subscription management server 7. Further, alternatively, when the IP-based OTA is employed, the provisioning network 6 provides IP connectivity between the subscription management server 7 and the device 1.

Hereinafter, details of configurations and operations for provisioning of the eUICC 10 will be further explained. The RAN node 2 is configured to, in response to receiving an attach request message from the device 1 equipped with the eUICC 10 in the initial state, transmit the attach request message to the provisioning network 6 of the initial MNO instead of the core network 3 of the initial MNO. The RAN node 2 is further configured to transmit, to the core network 3, an attach request message from a terminal (e.g., a cellular phone terminal, a smartphone, a provisioned M2M device/CCE) having a UICC that stores regular credentials of the initial MNO. That is, the RAN node 2 transmits an attach request message to either the core network 3 or the provisioning network 6 according to whether or not the access is made by the eUICC in the initial state. In other words, the RAN node 2 switches the destination of the attach request message between the core network 3 and the provisioning network 6 according to whether or not the access is made by the eUICC in the initial state.

As mentioned above, in the embodiment, when the eUICC 10 is in the initial state, the RAN node 2 transmits an attach request message from the eUICC 10 (device 1) to the provisioning network 6. As a result of this, connectivity between the subscription management server 7 necessary for provisioning of the eUICC 10 and the eUICC 10 is established. In the embodiment, a network to which the eUICC 10 (device 1) in the initial state attaches can be separated from the core network 3. Accordingly, the embodiment enables the device equipped with the eUICC in the initial state to be safely connected to the network operated by the initial MNO.

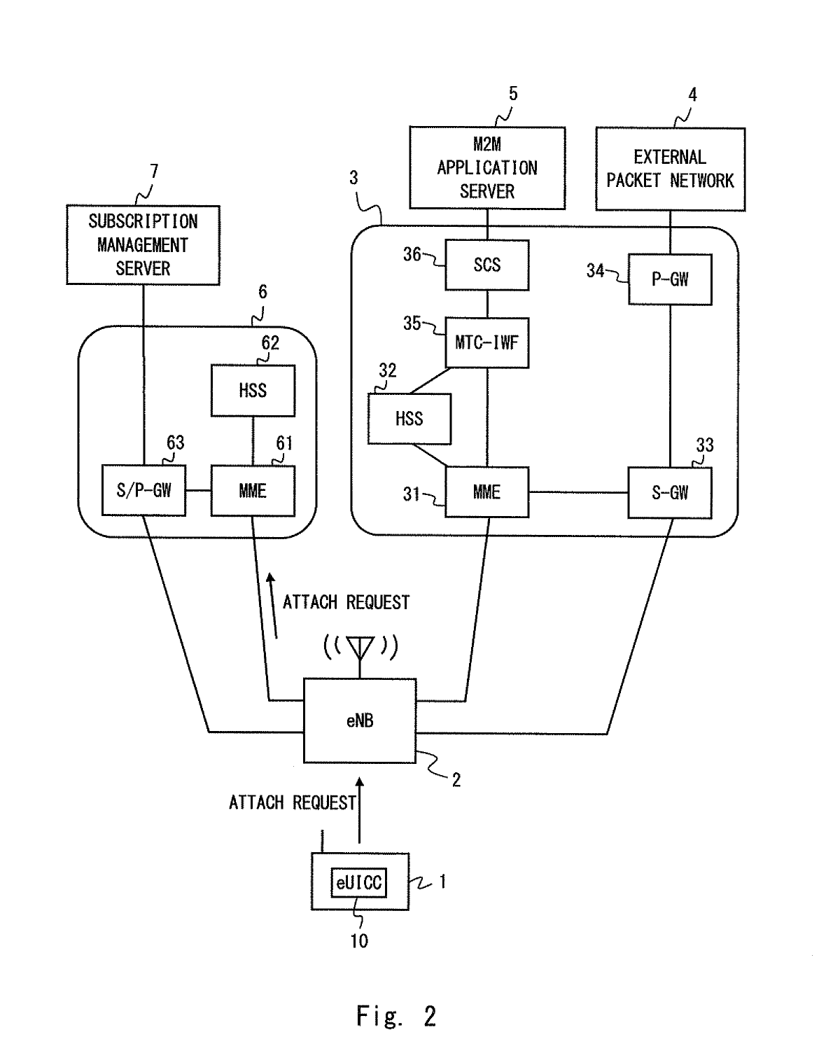

In the following, specific examples of configurations and operations of the radio communication system of the embodiment will be explained. FIG. 2 shows a configuration example in a case where the radio communication system of the embodiment is an LTE system. In this case, the RAN node 2 corresponds to a base station (i.e., an eNB). The core network 3 corresponds to an EPC. In the example shown in FIG. 2, the core network 3 includes: an MME (Mobility Management Entity) 31; an HSS (Home Subscriber Server) 32; an S-GW (Serving Gateway) 33; a P-GW (Packet Data Network Gateway) 34; an MTC-IWF (Machine Type Communication-Interworking Function) 35; and an SCS (Service Capability Server) 36.

The MME 31 is a control plane node, and performs, for example, mobility management (e.g., location registration) and bearer management (e.g., bearer establishment, bearer modification, bearer release) for terminals. That is, the MME 31 is a mobility management node. The MME 31 transmits and receives control messages (i.e., an S1AP message) to and from the RAN node (eNB) 2, and transmits and receives NAS (Non-Access Stratum) messages to and from terminals. The NAS messages are control messages transparently transmitted between terminals and the MME 31 without being terminated in an RAN and without being dependent on a radio access technology of the RAN. Specific examples of the NAS messages sent from terminals to the MME 31 include: an Attach Request; a Service Request; a PDN connectivity request; a Bearer Resource Allocation Request; a Bearer Resource Modification Request; a TAU (Tracking Area Update) Request; and a RAU (Routing Area Update) Request, etc.

The HSS 32 manages a database storing subscriber information. The HSS 32 transmits the subscriber information to the MME 31 in response to a request from the MME 31.

The S-GW 33 and the P-GW 34 transfer user packets between the RAN (specifically, the eNB 2) and the external packet network 4. For user packet transfer, the S-GW 33 establishes an S1-U bearer with the eNB 2, and establishes an S5/S8 bearer with the P-GW. The P-GW 34 transfers user packets between the S-GW 33 and the external packet network 4. The P-GW 34 allocates addresses (e.g., IP addresses) to terminals.

The MTC-IWF 35 provides the SCS 36 with a control plane interface for interworking with a core network of the 3GPP. The MTC-IWF 35 provides, for example, a function of triggering an M2M device, and a function of transferring small data on a downlink or an uplink or both of them. The SCS 36 may be called an M2M server. The SCS 36 provides the M2M application server 5 with an API.

In the example of FIG. 2, the provisioning network 6 includes an MME 61, an HSS 62, and an S/P-GW 63. The MME 61 receives from the eNB 2 an attach request message transmitted from the device 1 having the eUICC 10 in the initial state, and controls attach of the device 1 to the provisioning network 6. The HSS 62 manages subscriber information corresponding to initial credentials of the eUICC 10 in the initial state. However, the HSS 62 may be omitted. In this case, an operator may previously set, in the MME 61, an APN (Access Point Name) and a P-GW (S/P-GW 63 in FIG. 2) to which the eUICC 10 in the initial state should be connected. In addition, the subscription management server 7 may perform authentication of the eUICC 10 in the initial state. Alternatively, the HSS 62 and the HSS 32 may be integrated. In addition, the S/P-GW 63 may be implemented as a physical transfer node in which S-GW functions and P-GW functions have been integrated. Alternatively, the S/P-GW 63 may include a physical transfer node corresponding to a S-GW and a physical transfer node corresponding to a P-GW.

Functions of the MME 61 and the S/P-GW 63 shown in FIG. 2 may be arranged in the same site (building) as the eNB 2. As a result of this, traffic regarding provisioning of the eUICC can be offloaded at the eNB site. The subscription management server 7 transmits and receives the offloaded traffic via, for example, an IP network. In this case, the provisioning network 6 can also be regarded as the IP network.

In addition, also in cases of UMTS or GSM, a network may be configured by an idea similar to the example of LTE shown in FIG. 2. For example, in the case of UMTS, a control plane of an SGSN (Serving GPRS Support Node) may perform operations of the MME 61 of FIG. 2. An HLR (Home Location Register) may perform operations of the HSS 62. A user plane function of the SGSN or a GGSN (Gateway GPRS Support Node) may perform operations of the S/P-GW 63.

Hereinafter, several specific examples of switching destination of an attach request message according to whether or not the access is made by the eUICC in the initial state will be explained.

### SPECIFIC EXAMPLE 1

In the specific example 1, an attach request message when the eUICC 10 is in the initial state indicates a provisioning network. Not the attach request message itself, but a message transmitted from the device 1 in relation to the attach request message may indicate the provisioning network. An information element transmitted from the device 1 together with the attach request message may indicate the provisioning network. For example, an information element “Selected PLMN Identity” in an RRC Connection Setup Complete message transmitted by a terminal of LTE during an RRC connection establishment procedure may indicate the provisioning network. Note that anther information element “Dedicated NAS Information” in the RRC Connection Setup Complete message indicates an Attach Request Message.

That is, in the specific example 1, the device 1 selects a network to attach, and transmits selected network information to the RAN node 2. The selected network information indicates the network selected by the device 1. When the eUICC 10 is in the initial state, the device 1 selects the provisioning network 6 as an attach destination, and transmits the selected network information indicating the provisioning network 6.

In order to enable the device 1 to select a network, the RAN node 2 may broadcast system information indicating that both the core network 3 and the provisioning network 6 can be utilized. In this case, the device 1 may receive the broadcasted system information, and may transmit the selected network information indicating the provisioning network 6 together with the attach request message when the eUICC 10 is in the initial state.

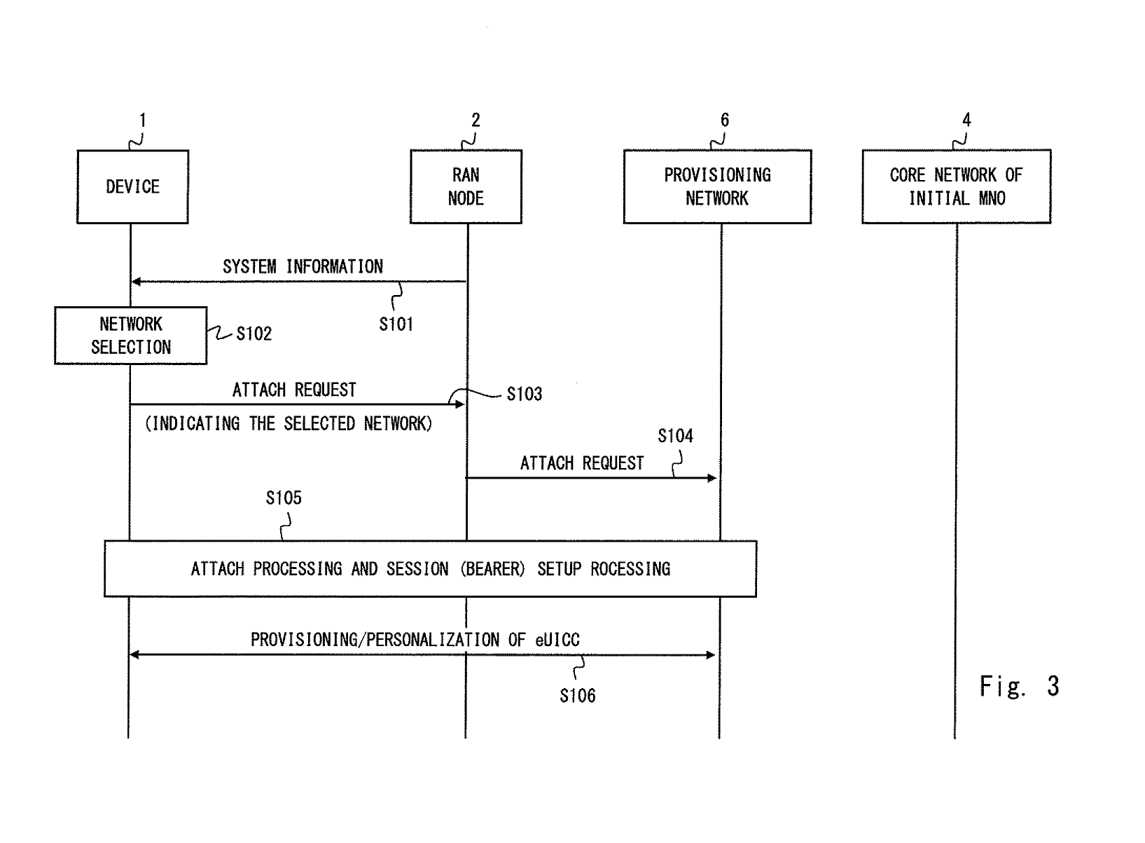

FIG. 3 is a sequence diagram showing one example of an eUICC provisioning procedure in the specific example 1. In step S101, the RAN node 2 broadcasts system information. The system information indicates that both the core network 3 and the provisioning network 6 can be utilized. In step S102, the device 1 receives the system information, and selects a network to attach among available networks. When the eUICC 10 is in the initial state, the device 1 selects the provisioning network 6 as already mentioned above. In step S103, the device 1 transmits an attach request message to the RAN node 2. The attach request message or a message (e.g., the selected network information) transmitted together with the attach request message indicates the provisioning network 6. In step S104, the RAN node 2 transmits the attach request message to the provisioning network 6 in accordance with network selection by the device 1. In step S105, attach processing and session (bearer) setup processing are executed among the provisioning network 6, the RAN node 2, and the device 1. Lastly, in step S106, the subscription management server 7, which is not shown, executes provisioning/personalization of the eUICC 10 through the provisioning network 6.

### SPECIFIC EXAMPLE 2

In the specific example 2, an attach request message when the eUICC 10 is in the initial state, or a message transmitted from the device 1 in relation to the attach request message indicates initial credentials stored in the eUICC. Alternatively, the attach request message or the message transmitted in relation thereto may indicate access by the eUICC in the initial state. Further, alternatively, the attach request message or the message transmitted in relation thereto may indicate access for provisioning of the eUICC. The access by the eUICC in the initial state or the access for provisioning of the eUICC may be indicated, for example, by attach type information in the attach request message. In response to receiving from the device 1 initial credentials, information indicating access by the eUICC in the initial state, or information indicating access for provisioning of the eUICC, the RAN node 2 transmits the attach request message from the device 1 to the provisioning network 6.

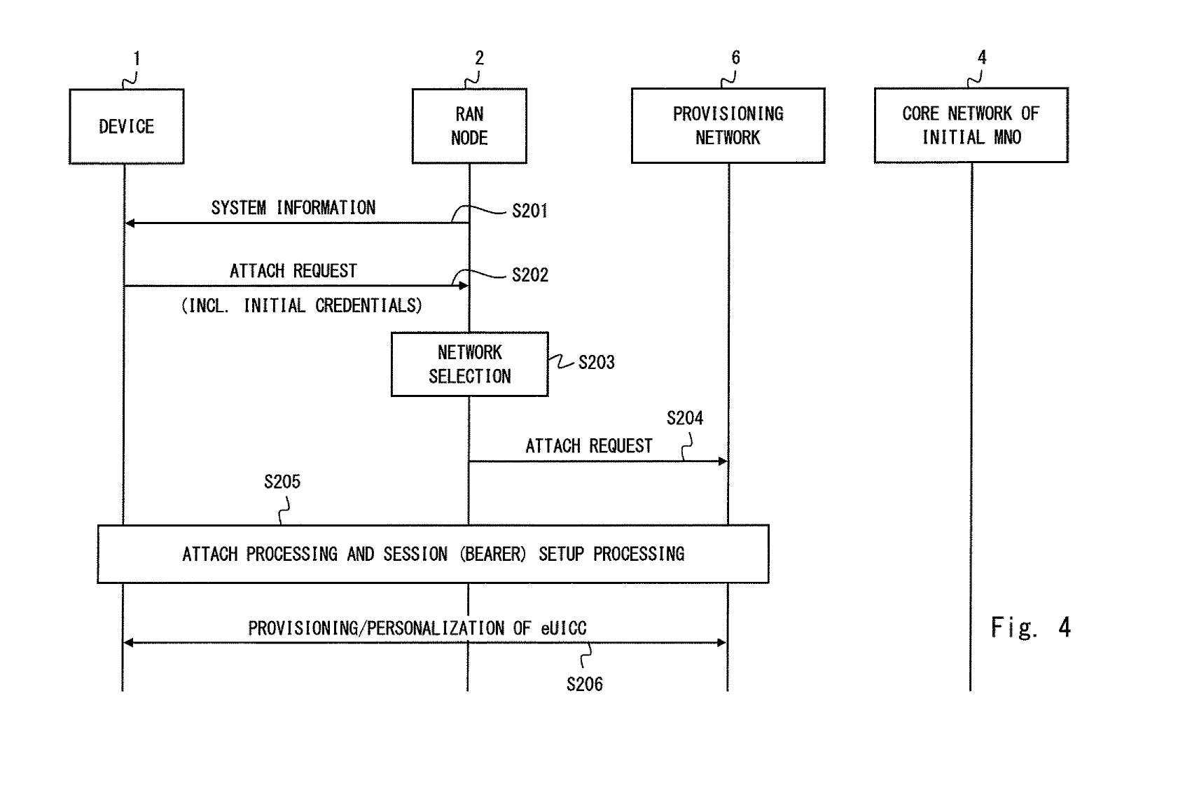

FIG. 4 is a sequence diagram showing one example of an eUICC provisioning procedure in the specific example 2. In step S201, the RAN node 2 broadcasts system information. In this example, the device 1 need not be able to recognize that a provisioning network can be utilized. For this reason, the system information of step S201 may indicate only that the core network 3 of the initial MNO 1 can be utilized. In step S202, the device 1 transmits an attach request message to the RAN node 2. In the example of FIG. 4, the attach request message includes initial credentials (e.g., an initial IMSI) associated with the eUICC in the initial state. In step S203, the RAN node 2 selects a network (e.g., an MME or an SGSN) based on credential contained in the attach request message. When the attach request message contains the initial credentials, the RAN node 2 selects the provisioning network 6, and transmits the attach request message to the provisioning network 6 (step S204). Processing of steps S205 and S206 is similar to processing of steps S105 and S106 of FIG. 3.

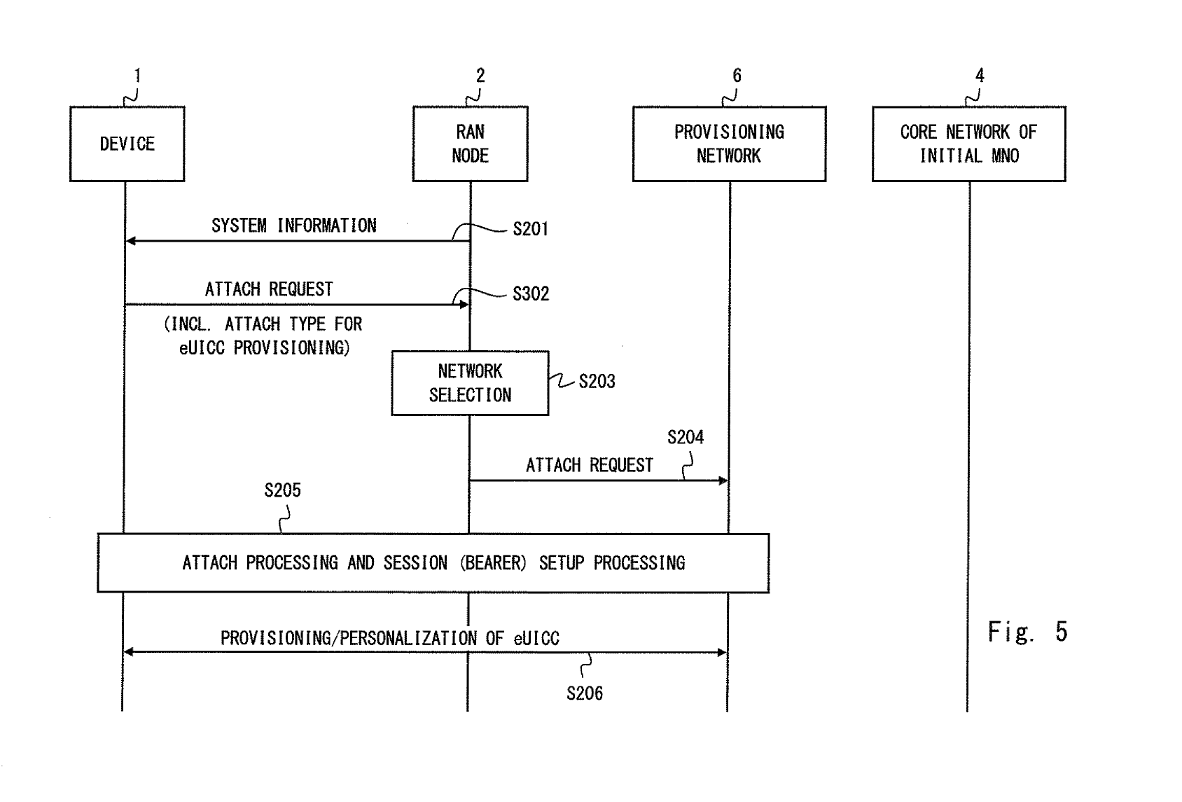

FIG. 5 is a sequence diagram showing another example of the eUICC provisioning procedure in the specific example 2. In step S302, the device 1 transmits to the RAN node 2 an attach request message containing attach type information indicating access for provisioning of the eUICC. Processing in other steps S201, and S203 to S206 is similar to processing in a step group of the same symbols shown in FIG. 4.

### SPECIFIC EXAMPLE 3

In the specific example 3, during an RRC (Radio Resource Control) connection establishment procedure initiated prior to transmission of an attach request message, the device 1 notifies the RAN node 2 of access by the eUICC in the initial state. The device 1 may notify the RAN node 2 of access for provisioning of the eUICC. In LTE, UMTS, GSM, etc., a terminal must establish RRC connection before transmission of the attach request message. For example, in a case of LTE, the device 1 transmits an RRC Connection Request message in a random access procedure. The RRC Connection Request message corresponds to an initial Layer 3 message. The RRC Connection Request message contains an establishment cause as one of the information elements. For example, the device 1 may indicate access by the eUICC in the initial state (or access for provisioning of the eUICC) using the establishment cause in the RRC Connection Request message.

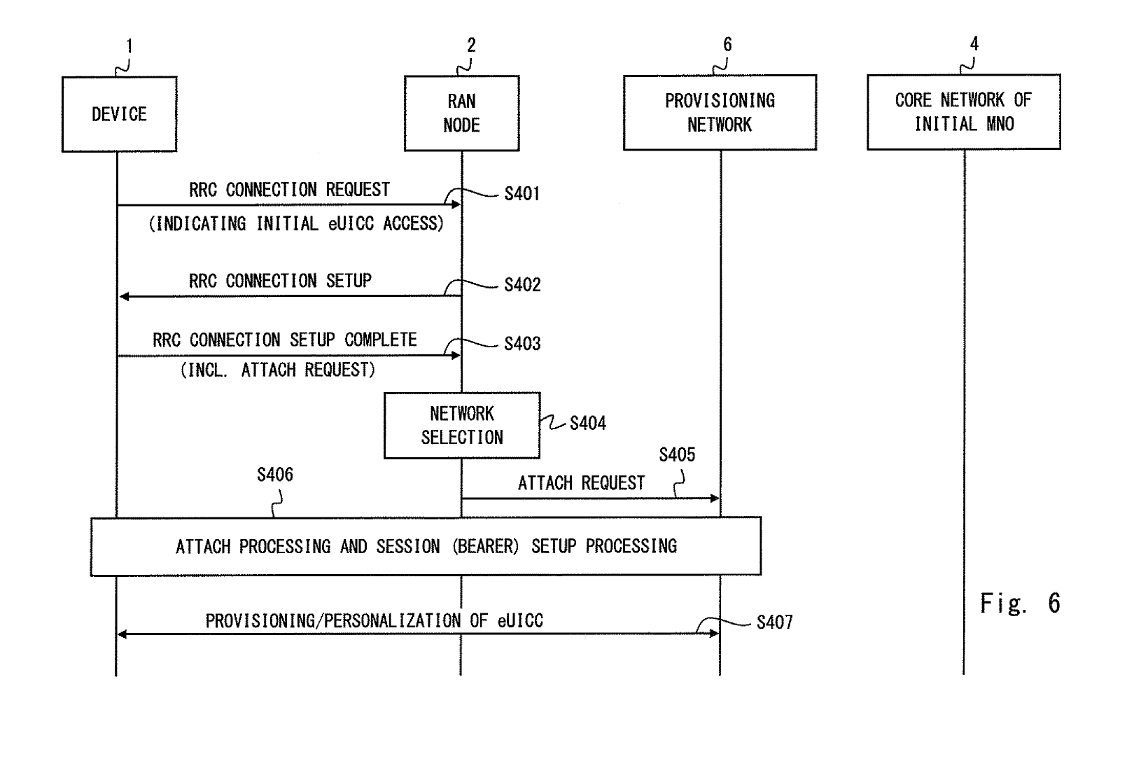

FIG. 6 is a sequence diagram showing one example of an eUICC provisioning procedure in the specific example 3. Steps S401 to S403 are based on an RRC connection establishment procedure in LTE. In step S401, the device 1 transmits an RRC Connection Request message to the RAN node 2. The RRC Connection Request message indicates access by the eUICC in the initial state. In step S402, the RAN node 2 transmits an RRC Connection Setup message. The device 1 that has received the RRC Connection Setup message transitions to an RRC Connected mode, and transmits an RRC Connection Setup Complete message (step S403). The RRC Connection Setup Complete message includes NAS information (here, an attach request message). In step S404, the RAN node 2 detects the attach request message is sent from the same source that transmitted the establishment cause (step S401) indicating access by the eUICC in the initial state, and then transmits the attach request message to the provisioning network 6 (steps S404 and S405). Processing of steps S406 and S407 is similar to the processing of steps S105 and S106 of FIG. 3.

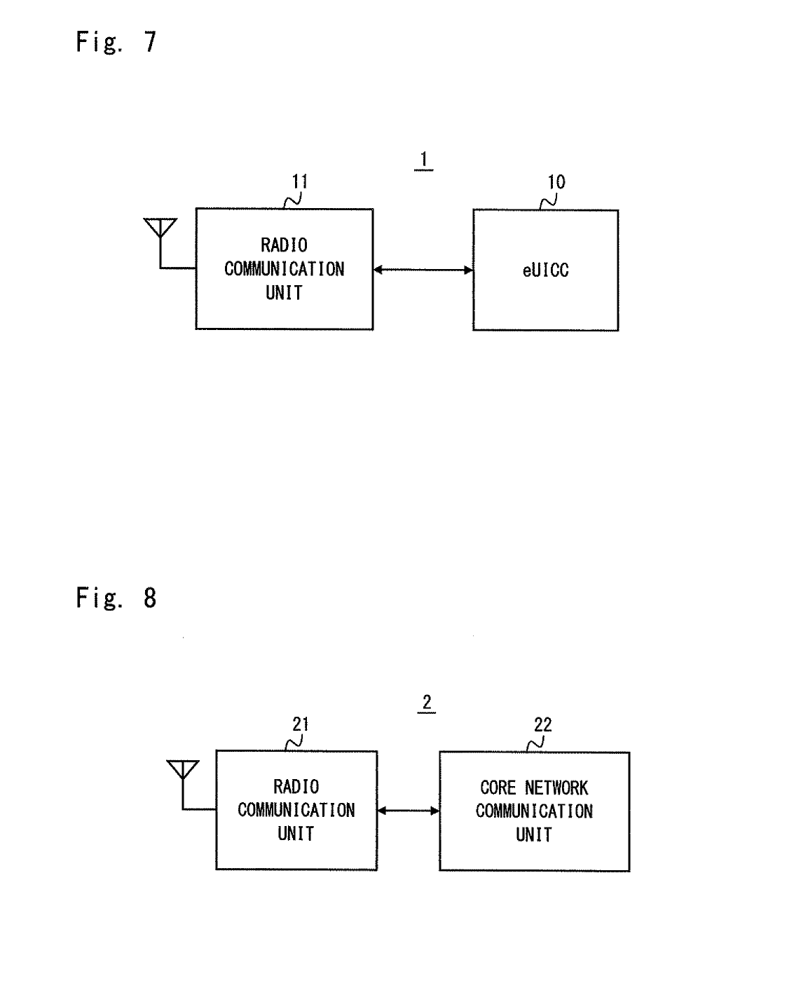

Hereinafter, configuration examples of the device 1 and the RAN node 2 will be explained. FIG. 7 is a block diagram showing the configuration example of the device 1. A radio communication unit 11 has an air interface, and is configured to communicate with the RAN node 2. The radio communication unit 11 is further configured to communicate with the eUICC 10, to read credentials stored in the eUICC 10, and to provide the eUICC 10 with data destined for the eUICC 10 and received through the air interface. The radio communication unit 11 may be implemented, for example, using a radio transceiver in conformity with a communication standard, such as LTE, UMTS or GSM, and a microprocessor that provides an execution environment of various programs.

FIG. 8 is a block diagram showing the configuration example of the RAN node 2. A radio communication unit 21 is configured to communicate with terminals including the device 1 equipped with the eUICC 10. A core network communication unit 22 is configured to communicate with the core network 3 and provisioning network 6 of the initial MNO. The core network communication unit 22 operates so as to transmit an attach request message from the device 1 equipped with the eUICC 10 in the initial state to the provisioning network 6 instead of the core network 3. The radio communication unit 21 may be implemented, for example, by a radio transceiver in conformity with a communication standard, such as LTE, UMTS or GSM. The core network communication unit 22 may be implemented using a communication processor that supports for example an LAN (Local Area Network) or an ATM (Asynchronous Transfer Mode) and a microprocessor that performs communication control including selection of transmission destination of an attach request message.

### Second Embodiment

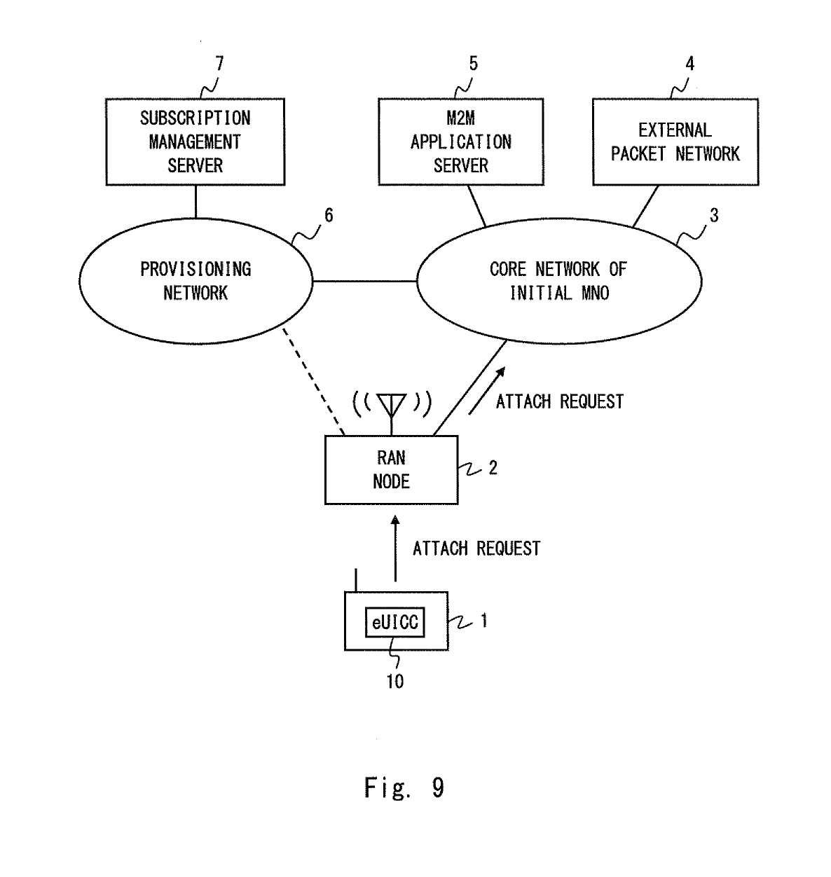

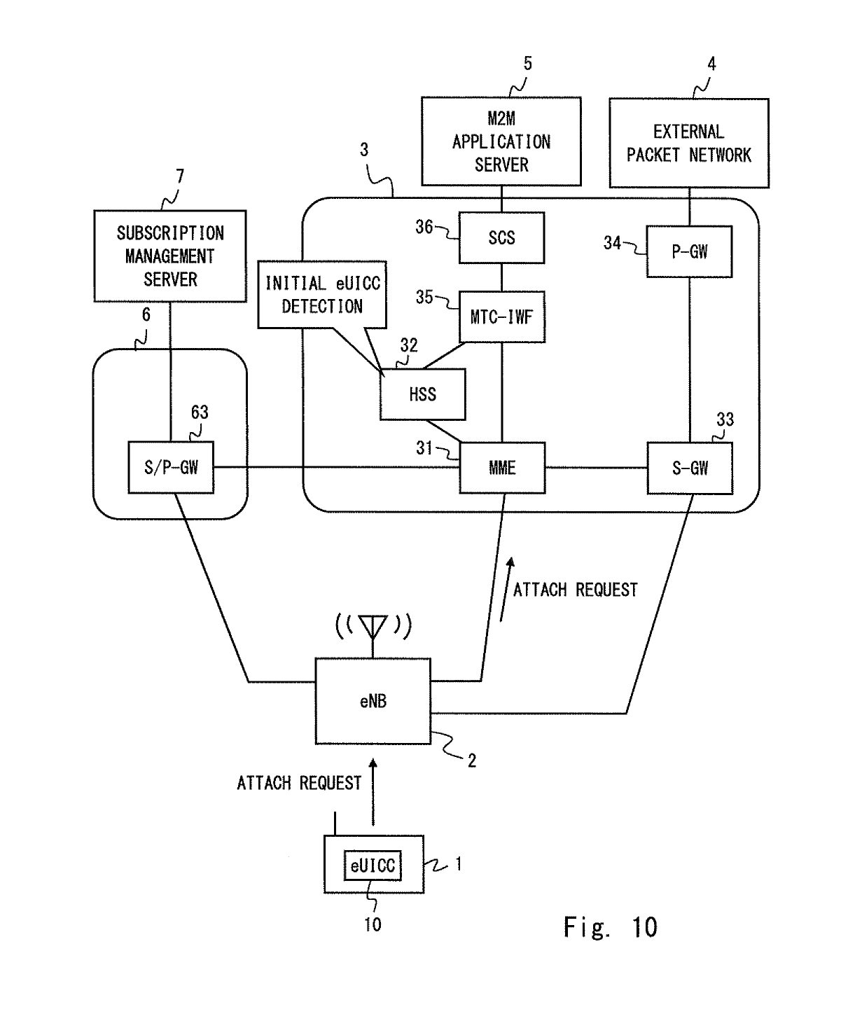

FIG. 9 shows a configuration example of a network including a radio communication system in accordance with the embodiment. In the embodiment, the RAN node 2 transmits an attach request message from the device 1 equipped with the eUICC 10 in the initial state to the core network 3 of the initial MNO. The attach request message contains initial credentials (e.g., an initial IMSI) stored in the eUICC 10. The core network 3 configures a communication path for provisioning of the device 1 based on the attach request message. The communication path provides connectivity between the subscription management server 7 and the eUICC 10. The communication path passes through the RAN node 2 and a transfer node (e.g., an S-GW and a P-GW, or an SGSN and a GGSN). There are various variations in arrangement of the transfer node. FIGS. 10 to 13 show several variations of arrangement of the transfer node in the case of LTE.

In a configuration example of FIG. 10, the provisioning network 6 includes the S/P-GW 63. The MME 31 receives an attach request message from the device 1 equipped with the eUICC 10 in the initial state and then transmits to the HSS 32 a location update request (an UPDATE LOCATION REQUEST) including initial credentials. The HSS 32 manages subscriber information associated with the initial credentials. The HSS 32 notifies the MME 31 of an APN associated with the initial credentials in response to the location update request including the initial credentials. That is, in the example of FIG. 10, the HSS 32 as a subscriber information server detects whether the eUICC is in the initial state or not. The MME 31 derives the corresponding P-GW (i.e., the S/P-GW 63) from the APN received from the HSS 32, and configures a communication path that goes through the eNB 2 and the S/P-GW 63. In the configuration example of FIG. 10, the communication path is directly configured between the eNB 2 and the provisioning network 6. Accordingly, since data traffic regarding provisioning of the eUICC is isolated from the core network 3, the configuration example of FIG. 10 can reduce security concerns.

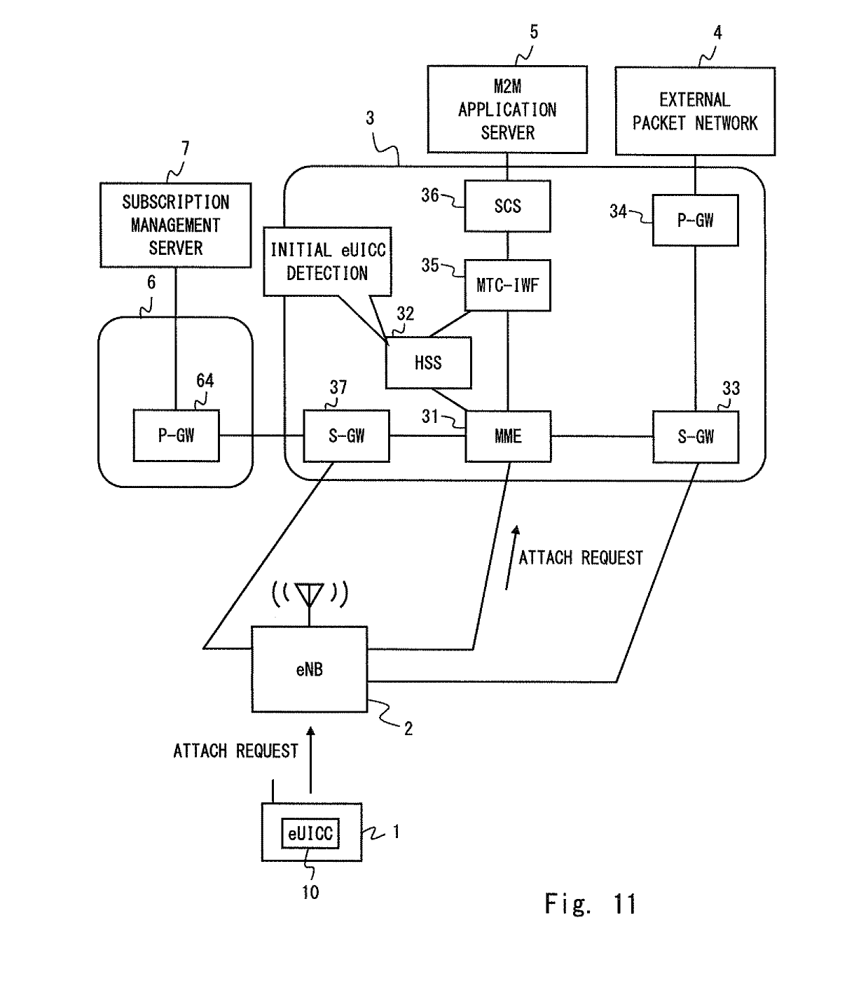

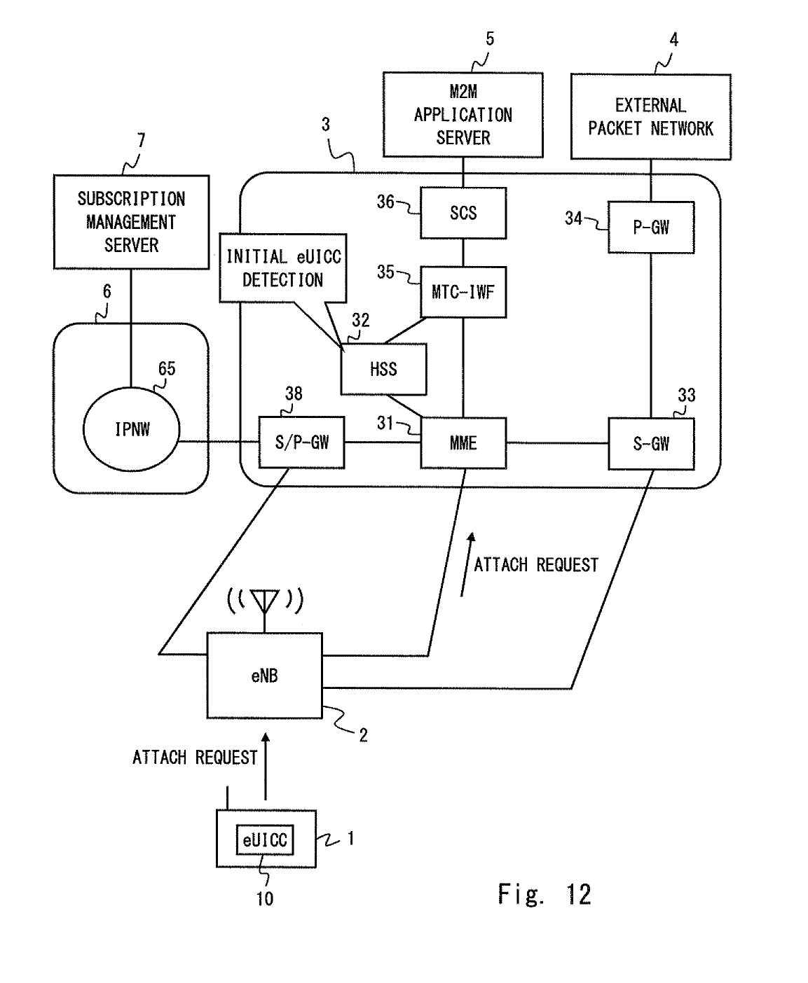

In a configuration example of FIG. 11, the provisioning network 6 includes a P-GW 64. A communication path between the subscription management server 7 and the eUICC 10 goes through an S-GW 37 arranged in the core network 3. The S-GW 37 may be integrated with the S-GW 33 that is used for other terminals each having a UICC or an eUICC that has stored regular credentials of the initial MNO.

In a configuration example of FIG. 12, the provisioning network 6 includes an IP network 65. The communication path between the subscription management server 7 and the eUICC 10 goes through an S/P-GW 38 arranged in the core network 3. The S/P-GW 38 may be a physical transfer node in which S-GW functions and P-GW functions have been integrated. Alternatively, the S/P-GW 38 may include a physical transfer node corresponding to a S-GW, and a physical transfer node corresponding to a P-GW. The S/P-GW 38 may be integrated with the S-GW 33 and the P-GW 34, which are used for other terminals each having a UICC or an eUICC that has stored regular credentials of the initial MNO.

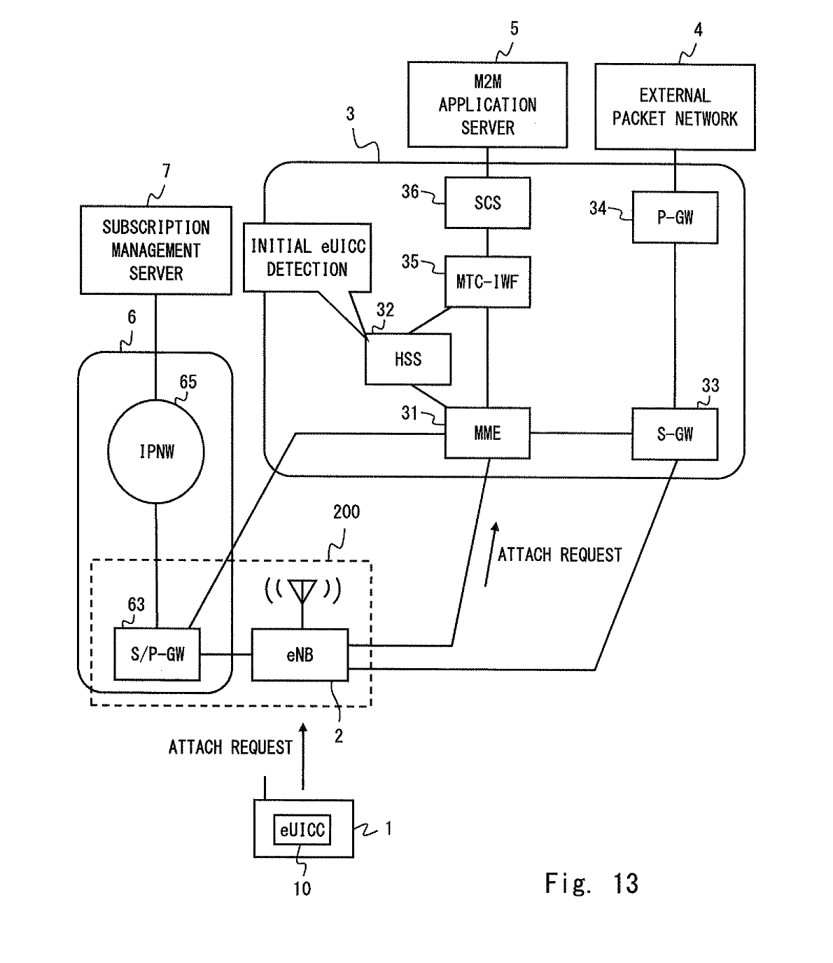

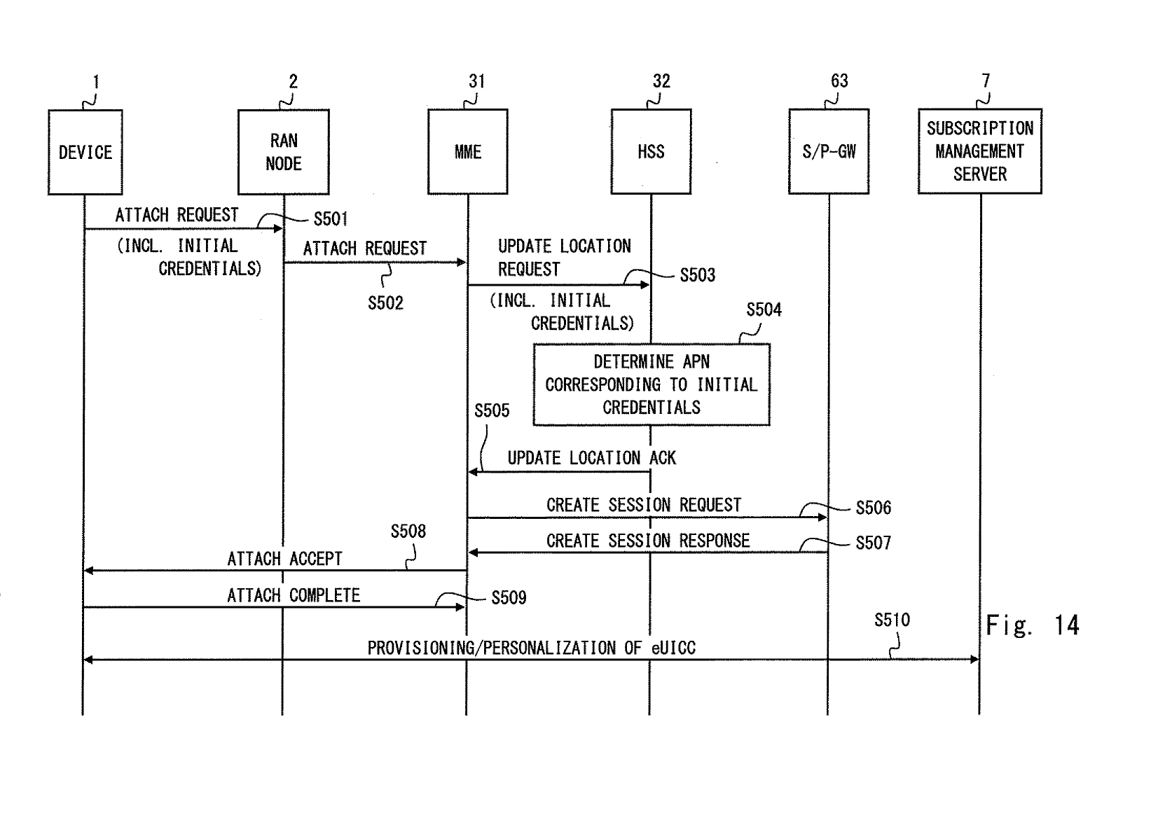

A configuration example of FIG. 13 shows a modified example of FIG. 10. As explained in the first embodiment, the S/P-GW 63 may be arranged in the same site (building) 200 as the eNB 2. In the example of FIG. 13, the provisioning network 6 includes the S/P-GW 63 and the IP network 65. Similarly, the S-GW 37 shown in FIG. 11 may be arranged in the same site as the eNB 2. Both the S-GW 37 and the P-GW 64 shown in FIG. 11 may be arranged in the same site as the eNB 2. In addition, the S/P-GW 38 shown in FIG. 12 may be arranged in the same site as the eNB 2.

FIG. 14 is a sequence diagram showing one example of an eUICC provisioning procedure in accordance with the embodiment. FIG. 14 is described regarding the LTE system. In step S501, the device 1 equipped with the eUICC 10 in the initial state transmits an attach request message to the RAN node (eNB) 2. The attach request message includes initial credentials (e.g., an initial IMSI). In step S502, the RAN node 2 transmits the attach request message to the MME 31 in response to reception of the attach request message from the device 1. In step S503, in response to receiving the attach request from the new device 1, the MME 31 transmits a location update request message (an Update Location Request message) to the HSS 32. The location update request contains the initial credentials (e.g., the initial IMSI) received from the device 1 (eUICC 10). In step S504, the HSS 32 determines an APN corresponding to the initial credentials. In step S505, the HSS 32 transmits to the MME 31 a location update response message (an Update Location ACK message) indicating the determined APN.

Steps S505 to S509 are similar to a usual bearer setup procedure in LTE. The MME 31 derives the P-GW and the S-GW (i.e., the S/P-GW 63) corresponding to the APN received from the HSS 32, and transmits a bearer setup request message (a Create Session Request message) to the S/P-GW 63 (step S506). The S/P-GW 63 performs bearer setup according to the bearer setup request, and transmits a response message (a Create Session Response message) to the MME 31 (step S507). In step S508, the MME 31 transmits an attach acceptance message (an Attach Accept message) to the device 1 through the RAN node 2. The RAN node 2 and the device 1 reconfigure the RRC connection based on the attach acceptance message. The device 1 then transmits an attach completion message (an Attach Complete message) to the MME 31 through the RAN node 2 (step S509).

In step S510, the subscription management server 7 executes provisioning/personalization of the eUICC 10 through the provisioning network 6.

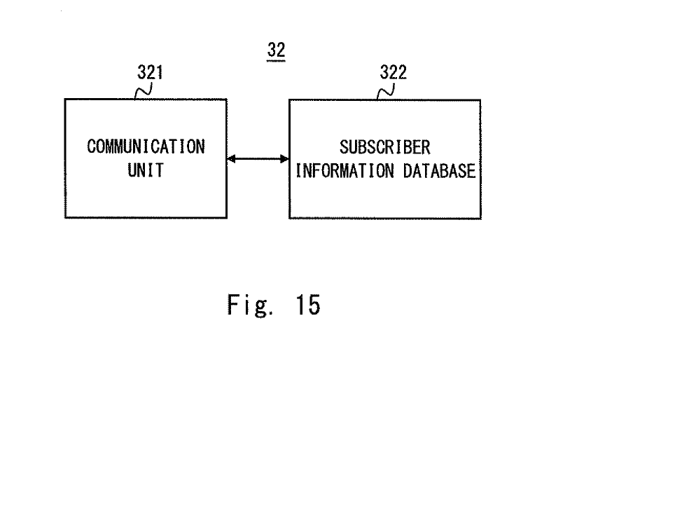

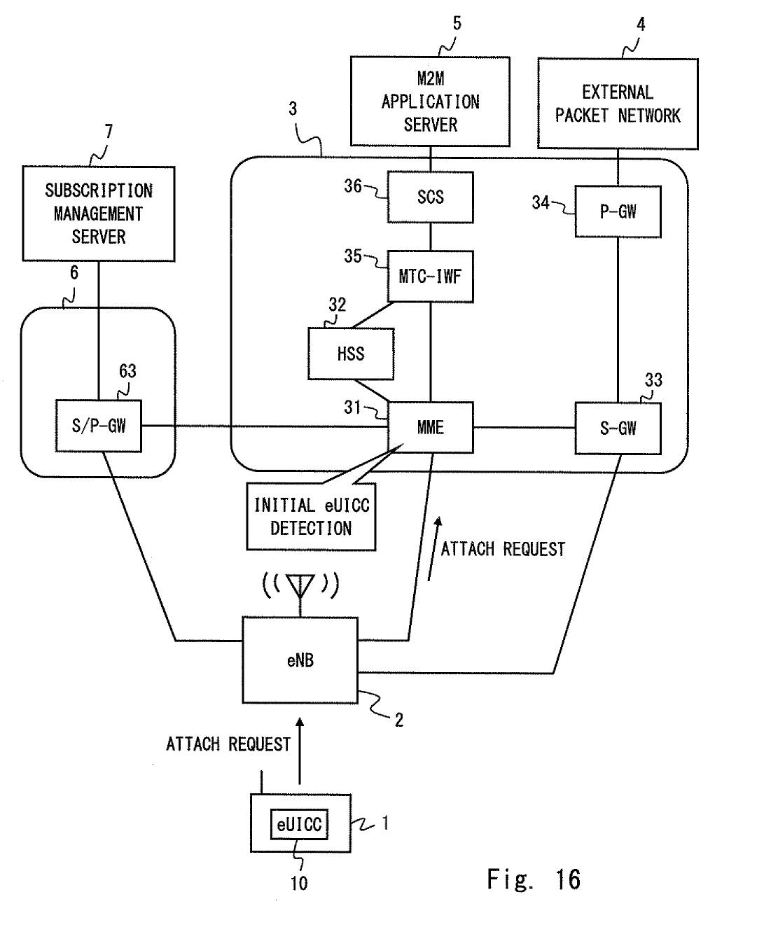

FIG. 15 is a block diagram showing a configuration example of the HSS 32 (i.e., a subscriber information server) in accordance with the embodiment. A communication unit 321 is configured to communicate with the MME 31 as a mobility management node. A subscriber information database 322 stores subscriber information. The communication unit 321 refers to the subscriber information database 322 in response to receiving a location update request containing initial credentials corresponding to the eUICC in the initial state. The communication unit 321 then transmits an answer message indicating an APN corresponding to the provisioning network 6. The communication unit 321 may be implemented using a communication processor that supports for example a LAN (Local Area Network) or an ATM (Asynchronous Transfer Mode), and a microprocessor that manages the subscriber information.

### Third Embodiment

In the second embodiment, the configuration has been shown that the subscriber information server (e.g., the HSS 32) detects access by the eUICC in the initial state. In the embodiment, an example is shown where a mobility management node (e.g., the MME 31) detects access by the eUICC in the initial state. As a result of this, for example, signaling between the mobility management node (e.g., the MME 31) and the subscriber information server (e.g., the HSS 32) is not needed, when the eUICC in the initial state is connected to the provisioning network.

FIG. 16 shows a configuration example of a radio communication system in accordance with the embodiment. The configuration example of FIG. 16 indicates a case of LTE. The configuration example of FIG. 16 corresponds to the configuration example of FIG. 10 explained in the second embodiment. In the embodiment, the device 1 transmits an attach request message indicating access for provisioning of the eUICC (or access by the eUICC in the initial state). For example, attach type information included in the attach request message can be used. Specifically, a new attach type may be defined to indicate access for provisioning of the eUICC (or access by the eUICC in the initial state). The MME 31 refers to the attach request message, and detects access for provisioning of the eUICC.

In order to skip signaling between the HSS 32 and the MME 31, an operator may previously set, in the MME 31, an APN (Access Point Name) and a P-GW (S/P-GW 63 in FIG. 16) to which the eUICC 10 in the initial state should be connected. As a result of this, the MME 31 that has received an attach request from the eUICC 10 in the initial state can decide to which S-GW and P-GW a bearer setup request message (a Create Session Request message) should be transmitted, without inquiring of the HSS 32.

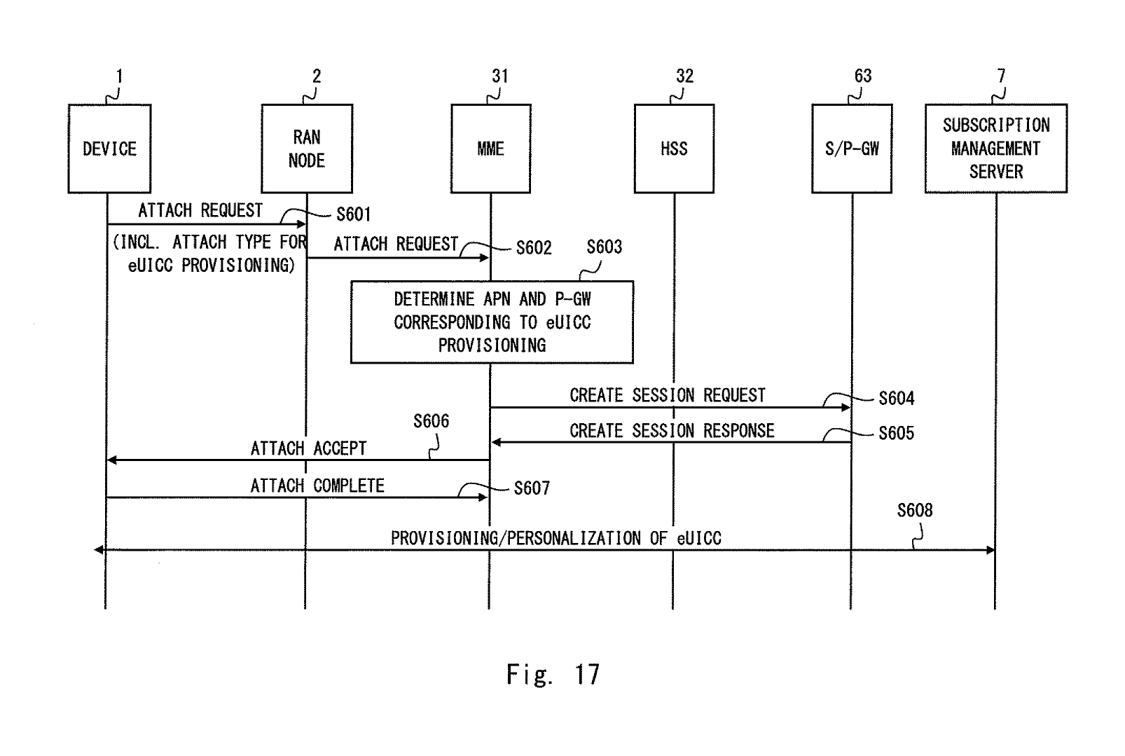

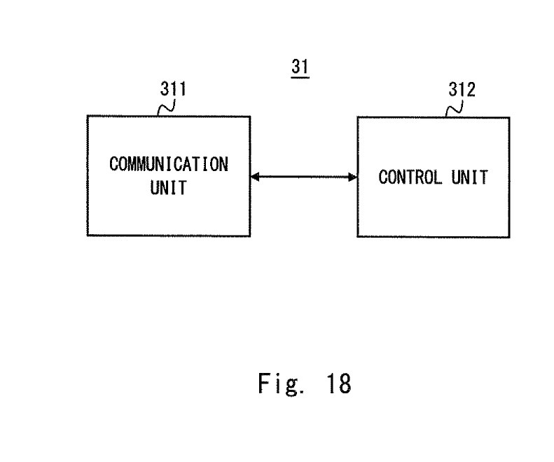

FIG. 17 is a sequence diagram showing one example of an eUICC provisioning procedure in accordance with the embodiment. FIG. 17 is described regarding the LTE system. In step S601, the device 1 equipped with the eUICC 10 in the initial state transmits an attach request message to the RAN node (eNB) 2. The attach request message contains attach type information indicating eUICC provisioning. In step S602, the RAN node 2 transmits the attach request message to the MME 31 in response to reception of the attach request message from the device 1. In step S603, the MME 31 refers to the attach type information, and determines an APN and a P-GW corresponding to the eUICC provisioning. As already mentioned above, the MME 31 may select the APN and the P-GW that have been previously fixedly (statically) set for the eUICC provisioning. Processing in steps S604 to S608 is similar to processing in steps S506 to S510 of FIG. 14.

FIG. 18 is a block diagram showing a configuration example of the MME 31 in accordance with the embodiment, i.e., a mobility management node. A communication unit 311 is configured to communicate with the RAN node 2, the HSS 32, the S-GW 33, the S/P-GW 63, etc. A control unit 312 receives an attach request message from the device 1 through the RAN node 2 and then detects whether or not the attach request message indicates access for provisioning of the eUICC (or access by the eUICC in the initial state). When the attach request message indicates access for provisioning of the eUICC, the control unit 312 configures a communication path (a bearer) between a transfer node (e.g., the S/P-GW 63) corresponding to the provisioning network 6 and the RAN node 2. The communication unit 311 may be implemented by one or more communication processors that support for example a LAN (Local Area Network) or an ATM (Asynchronous Transfer Mode). The control unit 312 may be implemented using one or more microprocessors.

Note that in a network configuration in accordance with the embodiment, various variations in arrangement of a transfer node can be considered similarly to the second embodiment. Accordingly, the configuration example shown in FIG. 16 may be modified as shown in FIGS. 11 to 13.

### Other Embodiments

The processing performed by the eUICC 10, the device 1, the RAN node 2, the MME 31, the MME 61, and the HSS 32 described in the first to third embodiments may be implemented by causing a computer system including at least one processor (e.g., a microprocessor, a micro processing unit (MPU) or a digital signal processor (DSP)) to execute a program. More specifically, one or more programs including instructions for causing a computer system to perform the algorithms explained with reference to the flowcharts and sequence diagrams may be created and supplied to a computer system.

These programs can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), CD-ROM (Read Only Memory), CD-R, CD-R/W, and semiconductor memories (such as mask ROM, PROM (Programmable ROM), EPROM (Erasable PROM), flash ROM, RAM (random access memory), etc.). These programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Furthermore, the above-mentioned first to third embodiments have been mainly explained using the specific examples regarding LTE. However, the radio communication systems in accordance with the first to third embodiments may be other mobile communication systems including UMTS and GSM.

Furthermore, the embodiments stated above are merely examples of application of the technical ideas obtained by the present inventor. Needless to say, these technical ideas are not limited to those described in the above embodiments and may be changed in various ways.

This application is based upon and claims the benefit of priority from Japanese Patent Application No. 2012-280030 filed on Dec. 21, 2012, and the disclosure of which is incorporated herein in its entirety by reference.

### REFERENCE SIGNS LIST

1 DEVICE
2 RAN (RADIO ACCESS NETWORK) NODE
3 CORE NETWORK OF INITIAL MNO (MOBILE NETWORK OPERATOR)
4 EXTERNAL PACKET NETWORK
5 M2M (MACHINE TO MACHINE) APPLICATION SERVER
6 PROVISIONING NETWORK
7 SUBSCRIPTION MANAGEMENT SERVER
10 eUICC (embedded Universal Integrated Circuit Card)
11 RADIO COMMUNICATION UNIT
21 RADIO COMMUNICATION UNIT
22 CORE NETWORK COMMUNICATION UNIT
31 MME (MOBILITY MANAGEMENT ENTITY)
32 HSS (HOME SUBSCRIBER SERVER)
33 S-GW (SERVING GATEWAY)
34 P-GW (PACKET DATA NETWORK GATEWAY)
35 MTC-IWF (MACHINE TYPE COMMUNICATION-INTERWORKING FUNCTION)
36 SCS (SERVICE CAPABILITY SERVER)
37 S-GW
38 S/P-GW
61 MME
62 HSS
63 S/P-GW
64 P-GW
65 IP (INTERNET PROTOCOL) NETWORK
311 COMMUNICATION UNIT
312 CONTROL UNIT
321 COMMUNICATION UNIT
322 SUBSCRIBER INFORMATION DATABASE

1. A radio communication system comprising:
a device equipped with an embedded UICC in an initial state;
a radio access network node configured to communicate with the device;
a provisioning network arranged for provisioning of the embedded UICC;
a core network different from the provisioning network; and
a server configured to communicate with the device through the provisioning network for provisioning of the embedded UICC,
wherein the radio access network node transmits an attach request message received from the device to the provisioning network instead of the core network.

2. The radio communication system according to claim 1, wherein the attach request message or a message transmitted in relation to the attach request message indicates the provisioning network.

3. The radio communication system according to claim 2, wherein
the radio access network node is configured to broadcast system information indicating that both the core network and the provisioning network can be utilized, and
the device is configured to receive the system information, and transmit selected network information indicating the provisioning network when the embedded UICC is in the initial state.

4. The radio communication system according to claim 1, wherein the attach request message or a message transmitted in relation to the attach request message indicates initial credentials stored in the embedded UICC.

5. The radio communication system according to claim 1, wherein the attach request message or a message transmitted in relation to the attach request message indicates access by the embedded UICC in the initial state or access for provisioning of the embedded UICC.

6. The radio communication system according to claim 1, wherein during an RRC connection establishment procedure initiated prior to transmission of the attach request message, the device is configured to notify the radio access network node of an establishment cause indicating access by the embedded UICC in the initial state or access for provisioning of the embedded UICC.

7. The radio communication system according to claim 6, wherein the radio access network node is configured to detect whether or not the attach request message is transmitted from the same source that transmitted the establishment cause.

8. The radio communication system according to claim 1, wherein the server is configured to provide the device with credentials regarding a network of another mobile operator different from a mobile operator that provides the provisioning network and the core network.

9. A radio access network node comprising:
a first communication unit configured to communicate with a device equipped with an embedded UICC in an initial state;
a second communication unit configured to communicate with a provisioning network arranged for provisioning of the embedded UICC and a core network different from the provisioning network, wherein
the second communication unit is configured to transmit an attach request message received from the device to the provisioning network instead of the core network.

10. The radio access network node according to claim 9, wherein the attach request message or a message transmitted in relation to the attach request message indicates the provisioning network.

11. The radio access network node according to claim 10, wherein the first communication unit is configured to broadcast system information indicating that both the core network and the provisioning network can be utilized.

12. The radio access network node according to claim 10, wherein the second communication unit is configured to transmit to the provisioning network a first attach request message associated with the provisioning network, and transmits to the core network a second attach request message associated with the core network.

13. The radio access network node according to claim 9, wherein the attach request message or a message transmitted in relation to the attach request message indicates initial credentials stored in the embedded UICC.

14. The radio access network node according to claim 9, wherein the attach request message or a message transmitted in relation to the attach request message indicates access by the embedded UICC in the initial state or access for provisioning of the embedded UICC.

15. The radio access network node according to claim 9, wherein during an RRC connection establishment procedure initiated prior to reception of the attach request message, the first communication unit is configured to receive from the device an establishment cause indicating access by the embedded UICC in the initial state or access for provisioning of the embedded UICC.

16. The radio access network node according to claim 15, wherein the second communication unit is configured to detect whether or not the attach request message is transmitted from the same source that transmitted the establishment cause.

17. A communication device comprising:
a radio communication unit configured to communicate with a radio access network node; and
an embedded UICC,
wherein when the embedded UICC is in an initial state, the radio communication unit transmits, to the radio access network node, selected network information indicating a provisioning network arranged for provisioning of the embedded UICC.

18. The communication device according to claim 17, wherein the radio communication unit is configured to transmit the selected network information when transmitting an attach request message by the communication device.

19. The communication device according to claim 17, wherein the radio communication unit is configured to transmit the selected network information together with an attach request message.

20. A communication method in a radio access network node that is arranged to communicate with a provisioning network arranged for provisioning of an embedded UICC and a core network different from the provisioning network, the communication method comprising:
receiving an attach request message from a device equipped with the embedded UICC in an initial state; and
transmitting the attach request message to the provisioning network instead of the core network.

21. A communication method in a device equipped with an embedded UICC, the method comprising:
when the embedded UICC is in an initial state, transmitting, to a radio access network node, selected network information indicating a provisioning network arranged for provisioning of the embedded UICC.

22. A non-transitory computer readable medium storing a program for causing a computer to perform a communication method in a radio access network node that is arranged to communicates with a provisioning network arranged for provisioning of an embedded UICC and a core network different from the provisioning network, wherein
the communication method comprises:
receiving an attach request message from a device equipped with the embedded UICC in an initial state; and
transmitting the attach request message to the provisioning network instead of the core network.

23. A non-transitory computer readable medium storing a program for causing a computer to perform a communication method in a device equipped with an embedded UICC, wherein
the communication method comprises, when the embedded UICC is in an initial state, transmitting, to a radio access network node, selected network information indicating a provisioning network arranged for provisioning of the embedded UICC.

24. A subscriber information server comprising:
a database configured to store subscriber information; and
a communication unit configured to communicate with a mobility management node,
wherein, in response to receiving a location update request including initial credentials corresponding to an embedded UICC in an initial state, the communication unit transmits an answer message indicating an access point name corresponding to a provisioning network arranged for provisioning of the embedded UICC.

25. A mobility management node comprising:
a first communication unit configured to communicate with a radio access network node; and
a control unit,
wherein the control unit is configured to:
receive an attach request message from a device through the radio access network node; and
when the attach request message indicates access by an embedded UICC in an initial state or access for provisioning of the embedded UICC, configure a communication path between the radio access network node and a transfer node corresponding to a provisioning network arranged for provisioning of the embedded UICC.

26. The mobility management node according to claim 25, wherein the attach request message includes attach type information indicating access by the embedded UICC in the initial state or access for provisioning of the embedded UICC.
